(19) United States
(12) Patent Application Publication
(10) Pub. No.: US 2024/0364870 A1
(43) Pub. Date: Oct. 31, 2024

(54) Boundary Based Asymmetric Reference Line Offsets

(71) Applicant: Ofinno, LLC, Reston, VA (US)

(72) Inventors: Alexey Konstantinovich Filippov, Khimki (RU); Vasily Alexeevich Rufitskiy, Vladimir (RU); Damian Ruiz Coll, Reston, VA (US)

(73) Assignee: Ofinno, LLC, Reston, VA (US)

(21) Appl. No.: 18/766,054

(22) Filed: Jul. 8, 2024

Related U.S. Application Data
(63) Continuation of application No. PCT/US2023/010279, filed on Jan. 6, 2023.
(60) Provisional application No. 63/296,914, filed on Jan. 6, 2022.

(51) Int. Cl. H04N 19/105; H04N 19/159; H04N 19/176

(52) U.S. Cl. CPC H04N 19/105; H04N 19/159; H04N 19/176

(57) ABSTRACT

A coder determines, based on a position of a block relative to a boundary and a property of the block, a first reference line offset and a second reference line offset that are different. The coder determines samples of a reference line based on the first reference line offset and the second reference line offset. The coder predicts the block based on the samples of the reference line and an intra prediction mode.

### CROSS-REFERENCE TO RELATED APPLICATIONS

This application is a continuation of International Application No. PCT/US2023/010279, filed Jan. 6, 2023, which claims the benefit of U.S. Provisional Application No. 63/296,914, filed Jan. 6, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example set of multiple reference lines determined for multiple reference line (MRL) coding of a current block in accordance with embodiments of the present disclosure.

FIG. 18 illustrates an example intra prediction performed for a current block being encoded in accordance with embodiments of the present disclosure.

FIG. 19 illustrates an example correspondence table for determining a horizontal reference line offset and a vertical reference line offset in accordance with embodiments of the present disclosure.

FIG. 20 illustrates an example correspondence table for determining a horizontal reference line offset and a vertical reference line offset in accordance with embodiments of the present disclosure.

FIG. 21 illustrates an example mapping function table for determining a horizontal reference line offset and a vertical reference line offset in accordance with embodiments of the present disclosure.

FIG. 22 illustrates an example extended set of samples in accordance with embodiments of the present disclosure.

FIG. 23 illustrates an example in which asymmetric offsets may be used in accordance with embodiments of the present disclosure.

FIG. 24 illustrates another example in which asymmetric offsets may be used in accordance with embodiments of the present disclosure.

FIG. 25A illustrates an example reference sample substitution (or padding) of unavailable samples of a reference line in accordance with embodiments of the present disclosure.

FIG. 25B illustrates another example reference sample substitution (or padding) of unavailable samples of a reference line in accordance with embodiments of the present disclosure.

FIG. 26 illustrates an example implementation of TIMD in accordance with embodiments of the present disclosure.

FIG. 27 illustrates a flowchart of a method for determining a prediction of a sample based on a reference line offset in accordance with embodiments of the present disclosure.

FIG. 28 illustrates a block diagram of AOM's video codec in accordance with embodiments of the present disclosure.

FIG. 29 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

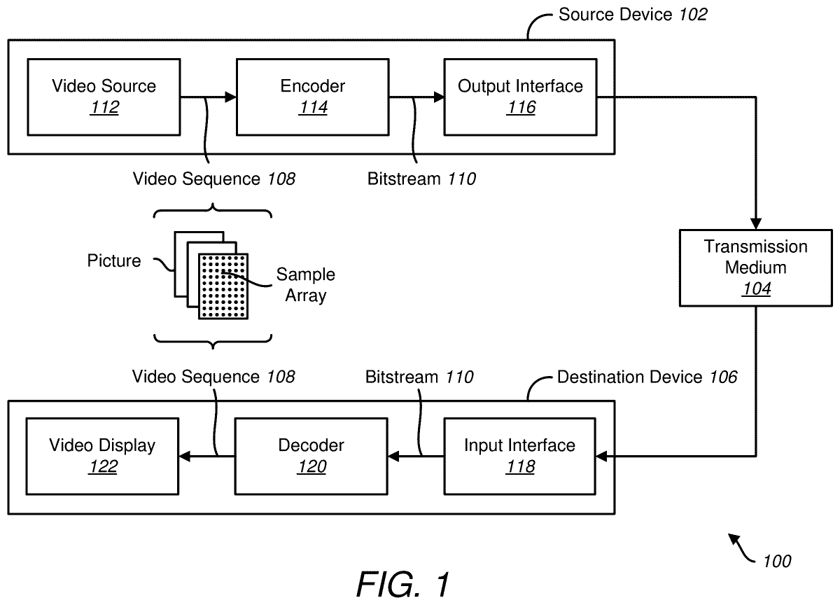

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bit stream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

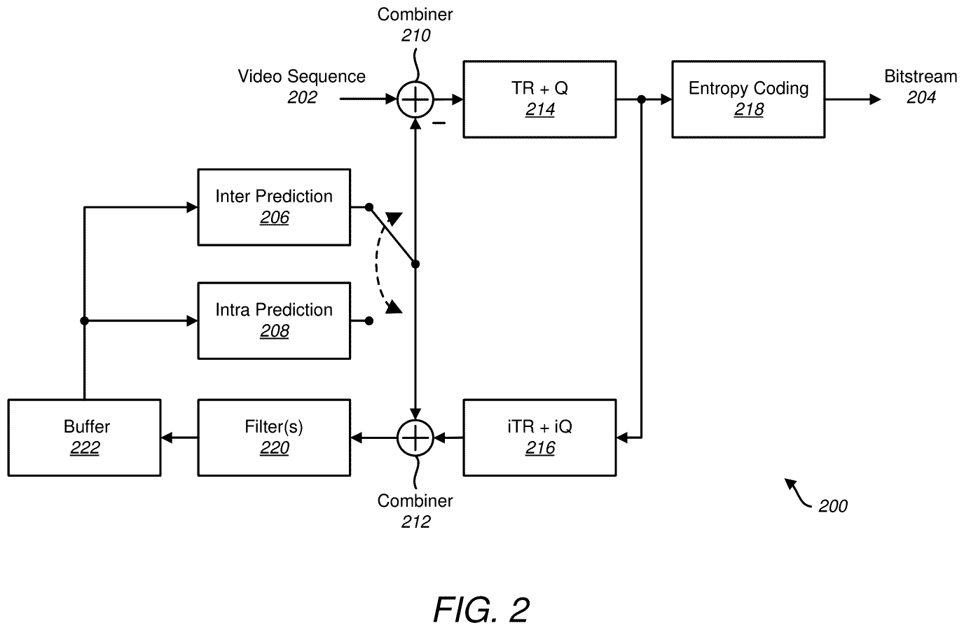

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, WVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

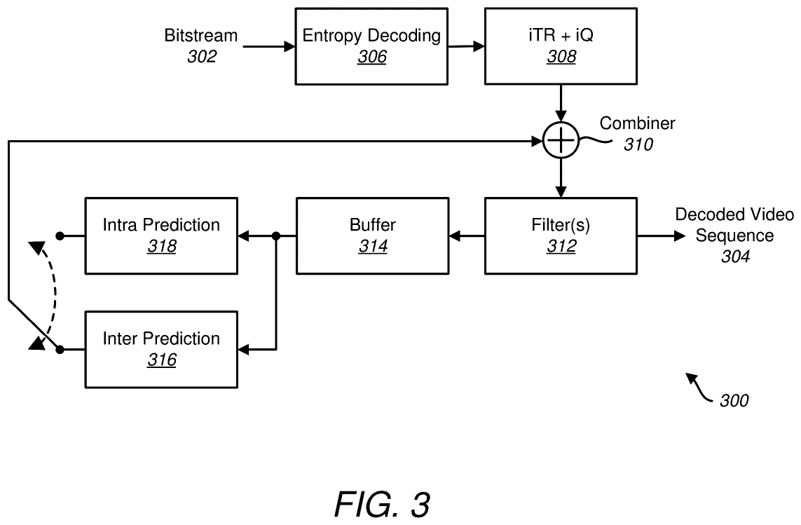

FIG. 3 illustrates an exemplary decoder 300 in which embodiments of the present disclosure may be implemented. Decoder 300 decodes an bitstream 302 into a decoded video sequence for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by inter prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2ⁿ×2ⁿ samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

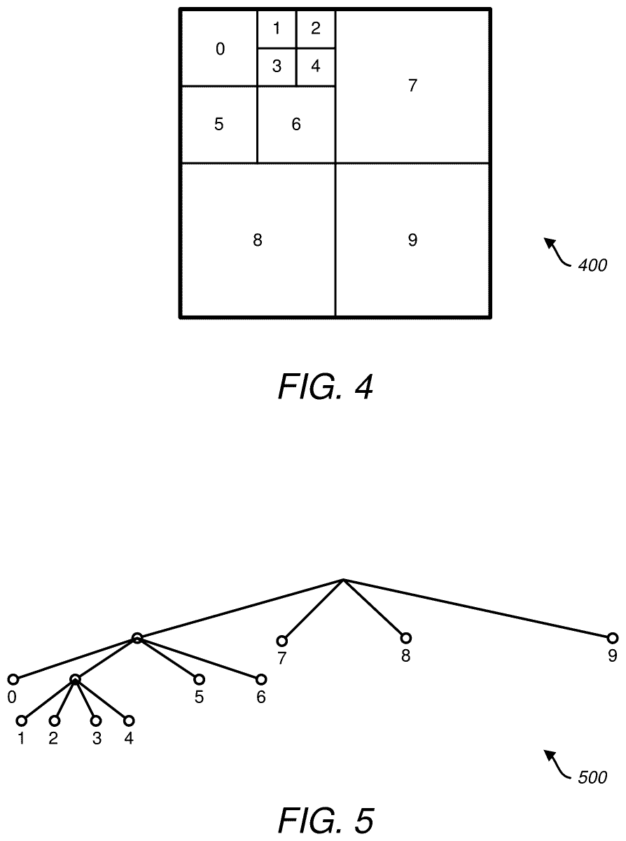

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

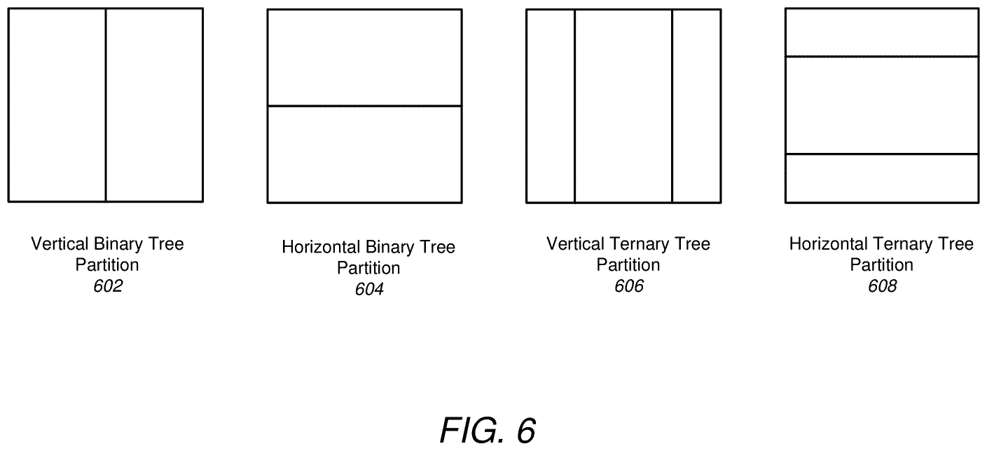

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

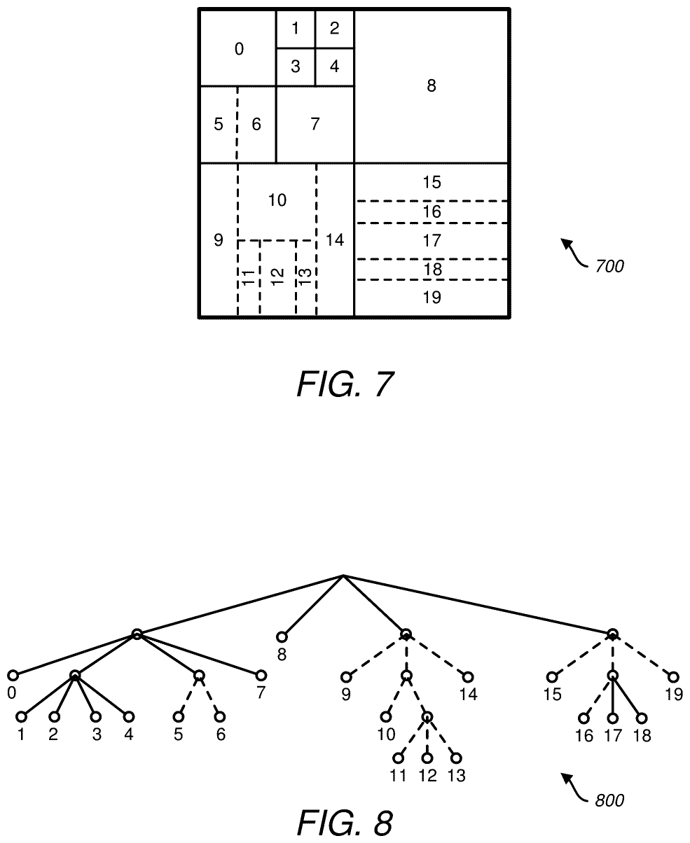

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

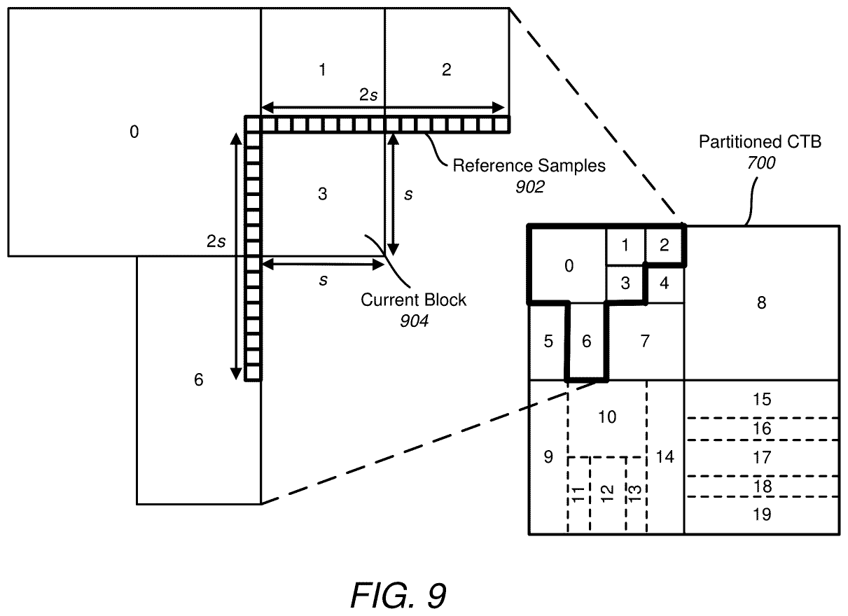

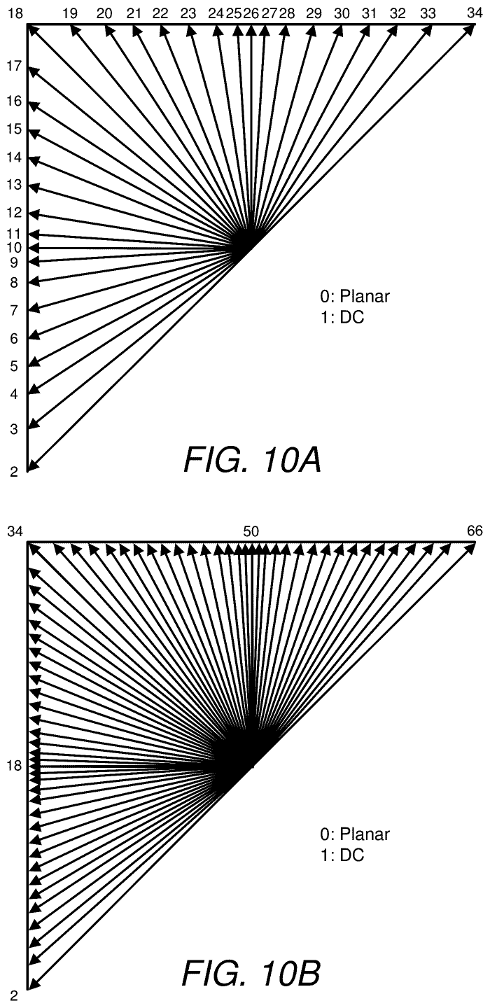

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in WVC may be non-square, some of the intra prediction modes illustrated in FIG. 10B may be adaptively replaced by wide-angle directions.

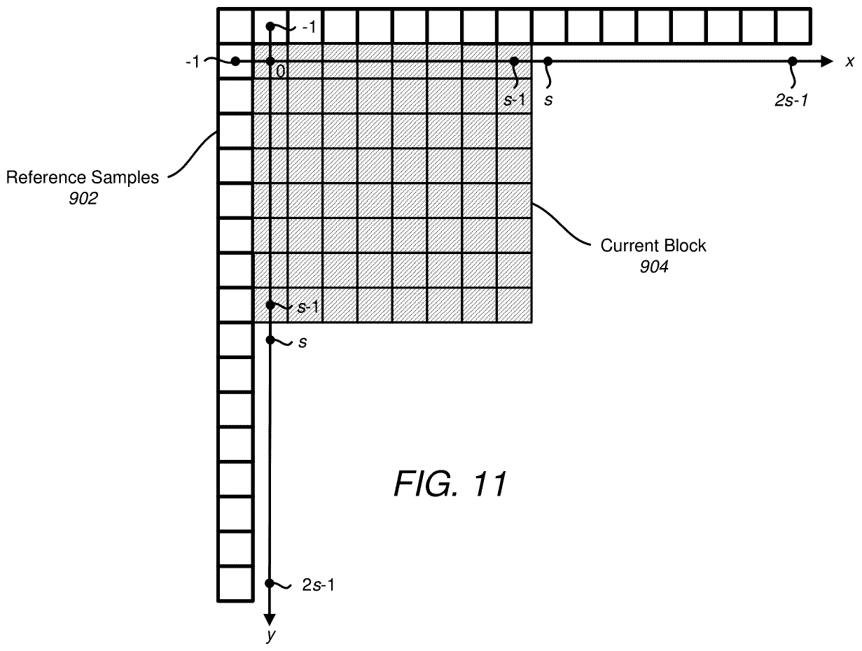

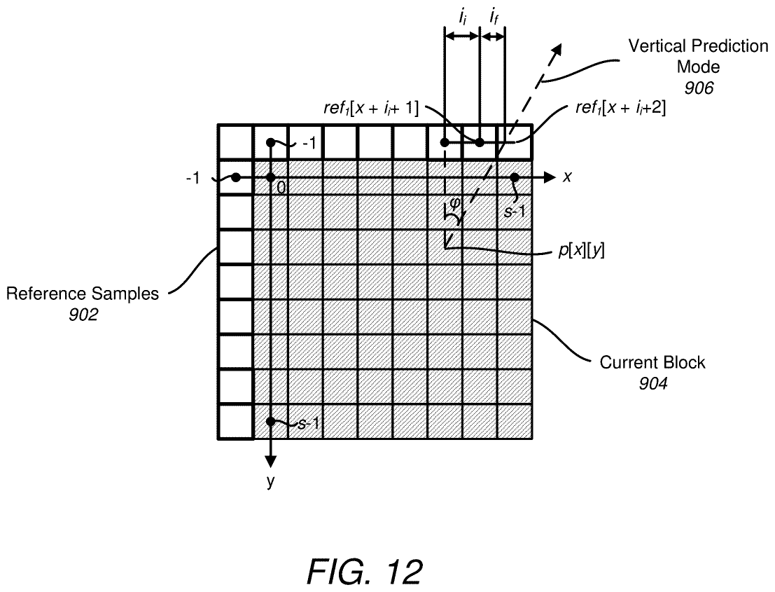

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x] [y]. In order to simplify the prediction process, reference samples 902 may be placed in two, one-dimensional arrays. Reference samples 902 above current block 904 may be placed in the one-dimensional array ref₁ [x]:

$${ref}_{1} [ x ] = p [ - 1 + x ] [ - 1 ] , ( x \geq 0 ) \qquad ( 1 )$$

Reference samples 902 to the left of current block 904 may be placed in the one-dimensional array ref₂ [x]:

$${ref}_{2} [ y ] = p [ - 1 ] [ - 1 + y ] , ( y \geq 0 ) \qquad ( 2 )$$

For planar mode, a sample at location [x] [y] in current block 904 may be predicted by calculating the mean of two interpolated values. The first of the two interpolated values may be based on a horizontal linear interpolation at location [x] [y] in current block 904. The second of the two interpolated values may be based on a vertical linear interpolation at location [x] [y] in current block 904. The predicted sample p[x] [y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at location [x] [y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at location [x] [y] in current block 904.

For DC mode, a sample at location [x] [y] in current block 904 may be predicted by the mean of the reference samples 902. The predicted value sample p[x] [y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x] [y] in current block 904 may be predicted by projecting the location [x] [y] in a direction specified by a given angular mode to a point on the horizontal or vertical line of samples comprising reference samples 902. The sample at location [x] [y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x] [y] in current block 904 for a vertical prediction mode 906 given by an angle q. For vertical prediction modes, the location [x] [y] in current block 904 is projected to a point (referred to herein as the “projection point”) on the horizontal line of reference samples ref₁ [x]. Reference samples 902 are only partially shown in FIG. 12 for ease of illustration. Because the projection point falls at a fractional sample position between two reference samples in the example of FIG. 12, the predicted sample p[x] [y] in current block 904 may be calculated by linearly interpolating between the two reference samples as follows

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x] [y] and may calculated as a function of the tangent of the angle q of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x] [y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x] [y] of a sample in current block 904 may be projected onto the vertical line of reference samples ref₂ [y]. Sample prediction for horizontal prediction modes is given by:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where iᵢ is the integer part of the vertical displacement of the projection point relative to the location [x] [y] and may be calculated as a function of the tangent of the angle φ of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x] [y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x] [y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on in_{f} similar to the two-tap FIR filter. For 1/32 sample accuracy, a set of 32 different four-tap FIR filters may comprise up to 32 different four-tap FIR filters-one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p[x] [y], for vertical prediction modes, may be determined based on the four-tap FIR filter as follows:

$$ρ [ x ] [ y ] = {Σ}_{i = 0}^{3} fT [ i ] * r e f [ x + iIdx + i ] \qquad ( 13 )$$

where ft[i], i=0 . . . 3, are the filter coefficients. The value of the predicted sample p[x] [y], for horizontal prediction modes, may be determined based on the four-tap FIR filter as follows:

$$ρ [ x ] [ y ] = {Σ}_{i = 0}^{3} fT [ i ] * r e f [ y + iIdx + i ] . \qquad ( 14 )$$

It should be noted that supplementary reference samples may be constructed for the case where the position [x] [y] of a sample in current block 904 to be predicted is projected to a negative x coordinate, which happens with negative vertical prediction angles q. The supplementary reference samples may be constructed by projecting the reference samples in ref₂ [y] in the vertical line of reference samples 902 to the horizontal line of reference samples 902 using the negative vertical prediction angle q. Supplemental reference samples may be similarly for the case where the position [x] [y] of a sample in current block 904 to be predicted is projected to a negative y coordinate, which happens with negative horizontal prediction angles q. The supplementary reference samples may be constructed by projecting the reference samples in ref₁ [x] on the horizontal line of reference samples 902 to the vertical line of reference samples 902 using the negative horizontal prediction angle q.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction modes as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

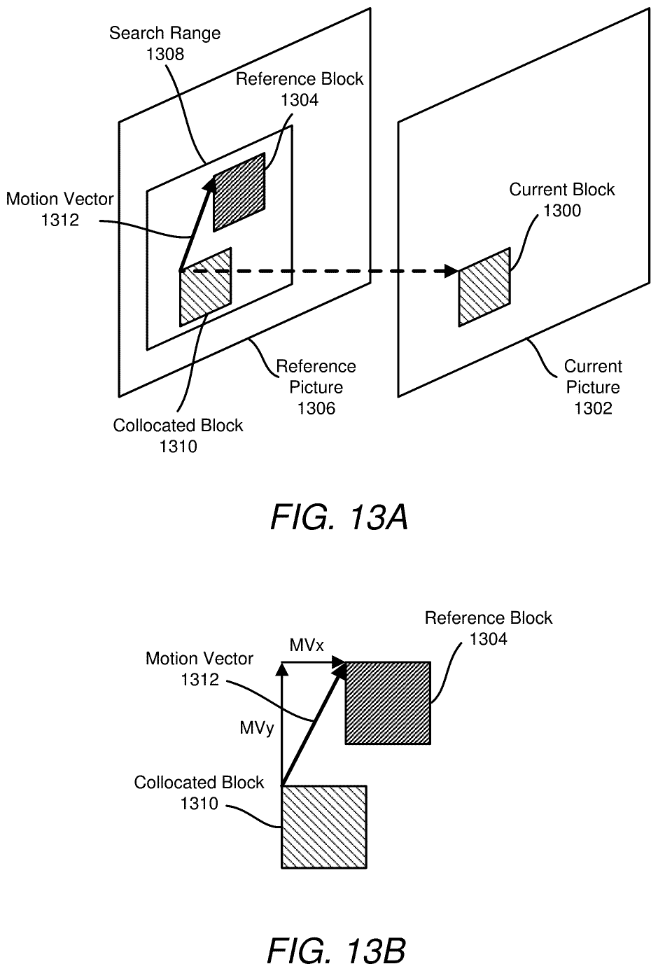

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVₓ) and a vertical component (MV_{y}) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

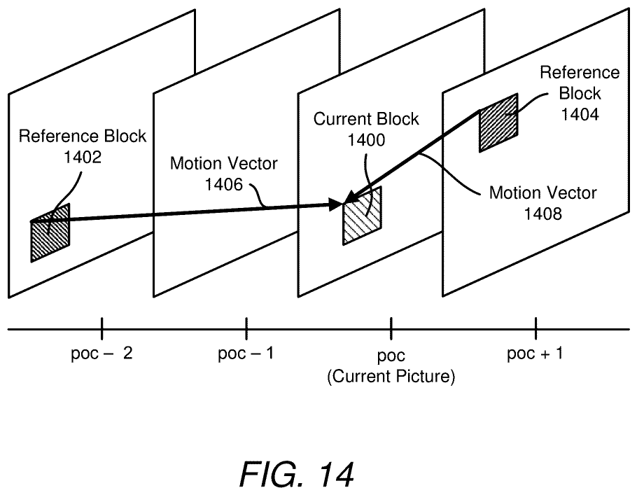

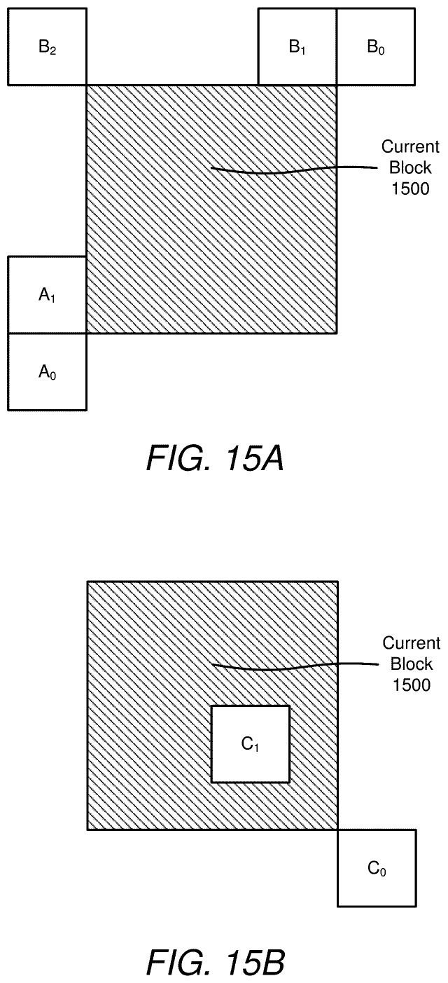

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or procced the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising reference picture of reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bit stream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVₓ) and a vertical displacement (MV_{y}) relative to the position of the current block being coded, the MVD may be represented by two components calculated as follows:

$$M V {D}_{x} = M {V}_{x} - M V {P}_{x} \qquad ( 15 )$$

$$MV {D}_{y} = M {V}_{y} - M V {P}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bit stream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

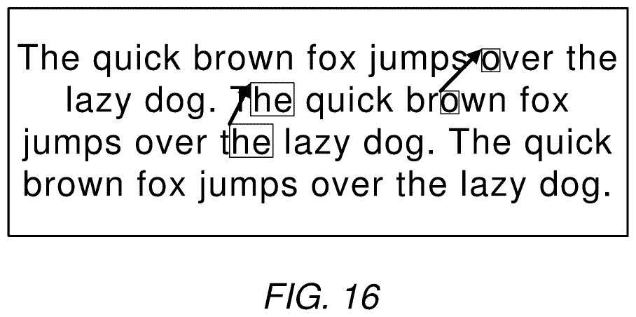

HEVC and VVC both include a prediction technique to exploit the correlation between blocks of samples within the same picture of screen content video. This technique is referred to as intra block (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bit stream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVx) and a vertical component (BVy) relative to the position of the current block being coded, the BVD may represented by two components calculated as follows:

$$B V {D}_{x} = B {V}_{x} - B V {P}_{x} \qquad ( 17 )$$

$$BV {D}_{y} = B {V}_{y} - B V {P}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

In the above description of FIGS. 9-12, intra prediction was used to determine a predicted value of a sample based on a reference line directly adjacent to the current block of the sample. In VVC, multiple reference line (MRL) coding was introduced to allow not only the reference line directly adjacent to a current block being encoded or decoded to be used for intra prediction but also non-directly adjacent reference lines. MRL coding was introduced in VVC because the reference line directly adjacent to the current block being encoded or decoded may not be strongly correlated with the samples of the current block due to, for example, a discontinuity in the content of the directly adjacent reference line. In such a case, a non-directly adjacent reference line may be used to perform intra prediction of a current block to reduce the prediction error. MRL coding is also currently being explored as a tool in the successor compression standard to VVC, referred to as the Enhanced Compression Model (ECM).

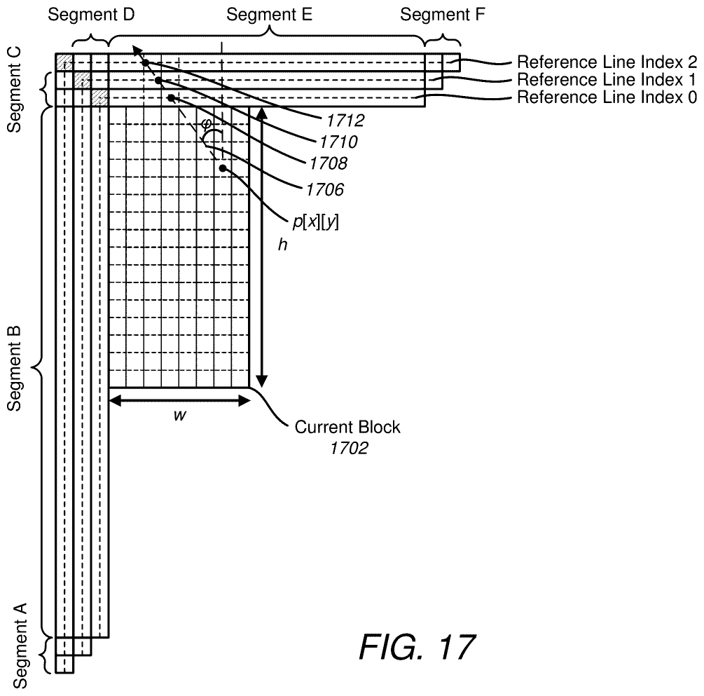

FIG. 17 illustrates an example intra prediction performed for a current block 1702 being encoded using multiple reference lines with indexes 0-2. Current block 1702 may be part of a picture, or sequence of pictures, representing a natural scene and/or a synthetically generated scene. When referring to a reference line, such as reference line 0 or 1, the number of the reference line indicates the index of the reference line. For example, reference line 0 refers to the reference line with an index of 0, and reference line 1 refers to the reference line with an index of 1. In the example of FIG. 17, current block 1702 is w×h samples in size and is rectangular in shape. In other examples, current block 1702 may be square or have a different, rectangular shape (e.g., a rectangular shape with a longer width than height).

The encoder may determine reference lines 0-2 for intra prediction of current block 1702. Reference line 0, which is the reference line directly adjacent to current block 1702, comprises a sample segment E with 2w samples in the row immediately adjacent to the top-most row of current block 1702, a sample segment B with 2h samples in the column immediately adjacent to the left-most column of current block 1702, and the top-left directly neighboring corner sample to current block 1702 shown with hatching. Reference line 0 has a sample length of L=2w+2h+1 and is marked with a dashed line.

Reference line n (n>0), which refers to the reference line removed from current block 1702 by n samples in the example of FIG. 17, comprises a sample segment E with 2w samples in the row n-samples above the top-most row of current block 1702, a sample segment B with 2h samples in the column n-samples to the left of the left-most column of current block 1702, sample segments D and F with n samples respectively to the left and right of segment E, sample segments A and C with n samples respectively below and above segment B, and a neighboring corner sample above segment C and to the left of segment D shown with hatching. Reference line n has a sample length of L=2w+2h+1+4n. Each reference line is marked with a dashed line.

The samples in the reference lines may come from reconstructed samples of neighboring blocks of current block 1702. In one embodiment, the samples of segments A and F may, instead of coming from reconstructed samples, be padded with the closest samples available from segments B and E, respectively.

The encoder may predict each sample of current block 1702 by projecting the location of the sample in current block 1702 in a given direction specified by an intra prediction mode to a point (referred to herein as a “projection point”) on the horizontal or vertical line of one of reference lines 0-2. FIG. 17 illustrates an example projection of a location [x] [y] of a sample in current block 1702. The encoder may project the location [x] [y] in a direction 1706 specified by a vertical intra prediction mode. Direction 1706 may be given by an angle φ defined relative to the y-axis for the vertical prediction mode. In other examples, a horizontal intra prediction mode may be used, in which case the angle q may be defined relative to the x-axis. The location [x] [y] may be projected to a projection point 1708 on the horizontal line of reference line 0, a projection point 1710 on the horizontal line of reference line 1, or a projection point 1712 on the horizontal line of reference line 2. If the projection point falls directly on a reference sample of the reference line to which it was projected, the value of the reference sample may be used as the predicted value for the sample. If the projection point falls at a fractional sample position between two reference samples on the reference line to which it was projected, the encoder may apply an interpolation filter to one or more of the reference samples available at integer sample positions on each side of the projection point. The interpolation filter may filter the reference samples to interpolate a value at the fractional sample position of the projection point. For example, a two-tap interpolation filter may be used for chroma samples and a four-tap interpolation filter may be used for luma samples. The encoder may determine the predicted sample value based on the interpolated value. The encoder may determine a prediction error for current block 1702 based on a difference (e.g., sum of squared differences (SSD), sum of absolute differences (SAD), or sum of absolute transformed differences (SATD) between the predicted samples, determined for the given intra prediction mode and reference line as explained above, and the original samples of current block 1702.

The encoder may perform this process of predicting samples and determining a prediction error, based on a difference between the predicted samples and original samples, for a plurality of different combinations of intra prediction modes and reference lines. For example, the encoder may perform this process for each combination of the 67 intra prediction modes in VVC, including non-angular (e.g., DC and planar) intra prediction modes, and reference lines 0-2. With 67 intra prediction modes and 3 reference lines, there are a total of 67*3 or 201 different intra prediction mode and reference line combinations. Thus, the encoder will determine a total of 67*3 or 201 predictions and prediction errors of current block 1702 if all such combinations are tested.

The encoder may select an intra prediction mode and reference line combination to encode current block 1702 based on the determined prediction errors. For example, the encoder may select an intra prediction mode and reference line combination that results in the smallest prediction error for current block 1702. In another example, the encoder may select the intra prediction mode and reference line combination to encode current block 1702 based on a rate-distortion measure determined using the prediction errors. The encoder may send an indication of a selected intra prediction mode, a selected reference line, and a corresponding prediction error for the selected intra prediction mode and selected reference line combination to a decoder for decoding of current block 1702. The encoder may send the indication of the selected reference line by signaling the index of the reference line. For example, the encoder may send index 0 in the bitstream for current block 1702 based on the encoder selecting reference line 0 as the selected reference line.

Angular intra prediction using multiple reference lines may be performed in the same manner as described above with respect to FIG. 12 except that the equations described above with respect to FIG. 12 may be generalized for any reference line. For example, equations (1) and (2), which are used to simplify the prediction process by placing the main reference samples in two, one-dimensional arrays, may be rewritten as:

$$r e {f}_{1} [ x ] = p [ - 1 + x - refIdx ] [ - 1 - refIdx ] , ( x \geq 0 ) \qquad ( 19 )$$

$$re {f}_{2} [ y ] = p [ - 1 - refIdx ] [ - 1 + y - refIdx ] , ( y \geq 0 ) \qquad ( 20 )$$

where refIdx is the reference line index of the reference line used for intra prediction. In addition, equations (8) and (9) for determining the integer and fractional part of the displacement for vertical intra prediction modes may be rewritten as:

$${i}_{i} = ⌊ ( y + 1 + refIdx ) \cdot tan φ ⌋ , \qquad ( 21 )$$

$${i}_{f} = ( ( y + 1 + refIdx ) \cdot tan φ ) - ⌊ ( y + 1 + refIdx ) \cdot tan φ ⌋ . \qquad ( 22 )$$

and equations (10) and (11) for determining the integer and fractional part of the displacement for horizontal intra prediction modes may be rewritten as:

$${i}_{i} = ⌊ ( x + 1 + refIdx ) \cdot tan φ ⌋ , \qquad ( 23 )$$

$${i}_{f} = ( ( x + 1 + refIdx ) \cdot tan φ ) - ⌊ ( x + 1 + refIdx ) \cdot tan φ ⌋ . \qquad ( 24 )$$

Equations 19-24 provide exemplary means for performing angular intra prediction using multiple reference lines. In other examples, different equations may be used to perform angular intra prediction.

It should be noted that, although the example intra prediction of FIG. 17 was described above as being performed at an encoder, a decoder may also perform a similar intra prediction. For example, a decoder may receive, from an encoder for a block, an indication of an intra prediction mode, an indication of a reference line from a plurality of reference lines (e.g., reference lines 0-2 in FIG. 17 or those tested by the encoder during intra prediction), and a residual. The decoder may construct or determine the samples of the indicated reference line and perform intra prediction based on the indicated intra prediction mode for the block in a similar manner as discussed above for the encoder. The decoder may add the predicted values of the samples of the block to the residual to reconstruct the block. In an embodiment, the decoder may not receive one or both of the indication of the intra prediction mode and the indication of the reference line from the encoder for the block. Instead, the decoder may determine one or both of the intra prediction mode and reference line through other means, such as decoder side means.

Although the use of multiple reference lines may increase coding gain, the complexity of the encoder also increases because the additional lines need to be tested during intra prediction. To reduce encoder complexity, the additional reference lines may be only tested for a subset of the intra prediction modes, such as those in a most probable mode (MPM) list. The MPM list may be adaptively generated for current block 1702 based on, for example, the availability and indices of intra prediction modes of the top and left neighboring blocks of current block 1702. The MPM list may be constructed in accordance with HEVC, VVC, or any other video coding standard. Moreover, the planar and DC intra prediction modes may be only applied to the reference line directly adjacent to current block 1702 (i.e., reference line 0) to further reduce encoder complexity. In such a case, a separate angular mode only MPM list may be constructed that includes only angular intra prediction modes. The additional reference lines may be only tested for the intra prediction modes in the angular mode only MPM list when such a list is used.

For each reference line 0-2 in FIG. 17, the one or more column segments of the reference line are offset from the left most column of current block 1702 (referred to herein as the “horizontal reference line offset”) by the same number of samples that the one or more row segments of the reference line are offset from the topmost row of current block 1702 (referred to herein as the “vertical reference line offset”). For example, column segment B of reference line 0 is offset from the left most column of current block 1702 by zero samples, and row segment E of reference line 0 is offset from the topmost row of current block 1702 by zero samples. Accordingly, reference line 0 has a horizontal reference line offset of zero and a vertical reference line offset of zero. Column segments A, B, and C of reference line 1 are offset from the left most column of current block 1702 by one sample, and row segments D, E, and F of reference line 1 are offset from the topmost row of current block 1702 by one sample. Accordingly, reference line 1 has a horizontal reference line offset of one and a vertical reference line offset of one. Finally, column segments A, B, and C of reference line 2 are offset from the left most column of current block 1702 by two samples, and row segments D, E, and F of reference line 2 are offset from the topmost row of current block 1702 by two samples. Accordingly, reference line 2 has a horizontal reference line offset of two and a vertical reference line offset of two. Because the horizontal and vertical reference line offsets of each reference line 0-2 shown in FIG. 17 are the same, the reference lines may be said to have symmetric reference line offsets.

Although a set of reference lines with symmetric horizontal and vertical reference line offsets may be used to perform intra prediction of a current block within a picture, reference lines with asymmetric reference line offsets (i.e., different horizontal and vertical reference line offsets) may provide better prediction results of a current block in some instances. However, there is no flexibility in existing technologies to adapt one or more reference lines used in multiple reference line prediction to have asymmetric reference line offsets in these instances. The set of reference lines used in existing technologies for MRL coding is static and comprised only of reference lines with symmetric reference line offsets.

Embodiments of the present disclosure are directed to methods and apparatuses for adapting one or more reference lines used to perform intra prediction of a current block being encoded or decoded. Embodiments of the present disclosure may adapt the one or more reference lines to have asymmetric reference line offsets. Embodiments of the present disclosure may adapt the one or more reference lines to have asymmetric reference line offsets based on at least one property of the current block being encoded or decoded. For example, embodiments of the present disclosure may adapt the one or more reference lines to have asymmetric reference line offsets based on a height, a width, both a height and a width, or an aspect ratio of the current block. These and other features of the present disclosure are described further below.

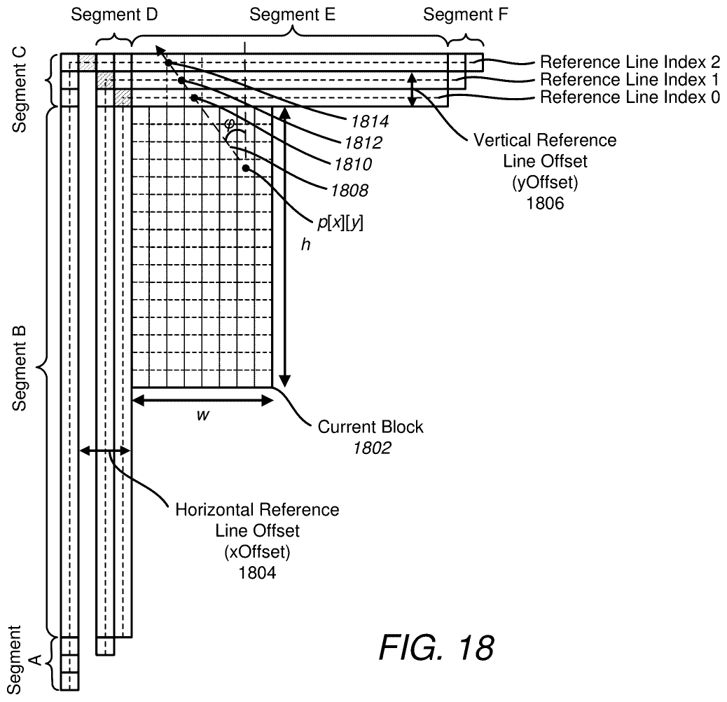

FIG. 18 illustrates an example intra prediction performed for a current block 1802 being encoded using multiple reference lines with indexes 0-2. Current block 1802 may be part of a picture, or sequence of pictures, representing a natural scene and/or a synthetically generated scene. When referring to a reference line, such as reference line 0 or 1, the number of the reference line indicates the index of the reference line. For example, reference line 0 refers to the reference line with an index of 0, and reference line 1 refers to the reference line with an index of 1. In the example of FIG. 18, current block 1802 is w×h samples in size and is rectangular in shape. In other examples, current block 1802 may be square or have a different, rectangular shape (e.g., a rectangular shape with a longer width than height or different dimensions than shown in general).

The intra prediction of FIG. 18 may be performed by an encoder, such as encoder 200 in FIG. 2. The encoder may determine reference lines 0-2 for intra prediction of current block 1802. As part of the determination, the encoder may determine a horizontal reference line offset and a vertical reference line offset for one or more of the reference lines 0-2. A horizontal reference line offset is the number of samples that the one or more column segments of a reference line are offset from the left most column of the current block. A vertical reference line offset is the number of samples that the one or more row segments of a reference line are offset from the topmost row of the current block. A reference line with equal horizontal and vertical reference line offsets is said to have symmetric reference line offsets. A reference line with different horizontal and vertical reference line offsets is said to have asymmetric reference line offsets. In one example, the encoder may determine the horizontal reference line offset and the vertical reference line offset for one or more of reference lines 0-2 based on a property of current block 1802.

In an example, the encoder may determine the horizontal reference line offset for one or more of reference lines 0-2 in FIG. 18 based on the height (h), the width (w), both the height (h) and the width (w), or an aspect ratio (e.g., h/w or w/h) of current block 1802. For example, the encoder may determine the horizontal reference line offset for one or more of reference lines 0-2 based on the height (h) of current block 1802. For example, based on the height (h) of current block 1802 being equal to or less than a first threshold, the encoder may determine the horizontal reference line offset to be equal to a first value. Based on the height (h) of current block 1802 being greater than the first threshold but less than or equal to a second threshold, the encoder may determine the horizontal reference line offset to be equal to a second value. The second value may be greater than or less than the first value. Based on the height (h) of current block 1802 being greater than the second threshold, the encoder may determine the horizontal reference line offset to be equal to a third value. The third value may be greater than or less than the second value. In other examples, more or less threshold values may be used to determine the horizontal reference line offset. For example, a single threshold may be used to determine the horizontal reference line offset. In addition, instead of the height (h) of current block 1802 being used, the width (w) of current block 1802 may be used to determine the horizontal reference line offset based on the one or more thresholds.

In another example, the encoder may determine the vertical reference line offset for one or more of reference lines 0-2 shown in FIG. 18 based on the height (h), the width (w), both the height (h) and the width (w), or an aspect ratio of current block 1802. For example, the encoder may determine the vertical reference line offset for one or more of reference lines 0-2 based on the width (w) of current block 1802. For example, based on the width (w) of current block 1802 being equal to or less than a first threshold, the encoder may determine the vertical reference line offset to be equal to a first value. Based on the width (w) of current block 1802 being greater than the first threshold but less than or equal to a second threshold, the encoder may determine the vertical reference line offset to be equal to a second value. The second value may be greater than or less than the first value. Based on the width (w) of current block 1802 being greater than the second threshold, the encoder may determine the vertical reference line offset to be equal to a third value. In other examples, more or less threshold values may be used to determine the vertical reference line offset. For example, a single threshold may be used to determine the vertical reference line offset. In addition, instead of the width (w) of current block 1802 being used, the height (h) of current block 1802 may be used to determine the vertical reference line offset based on the one or more thresholds.

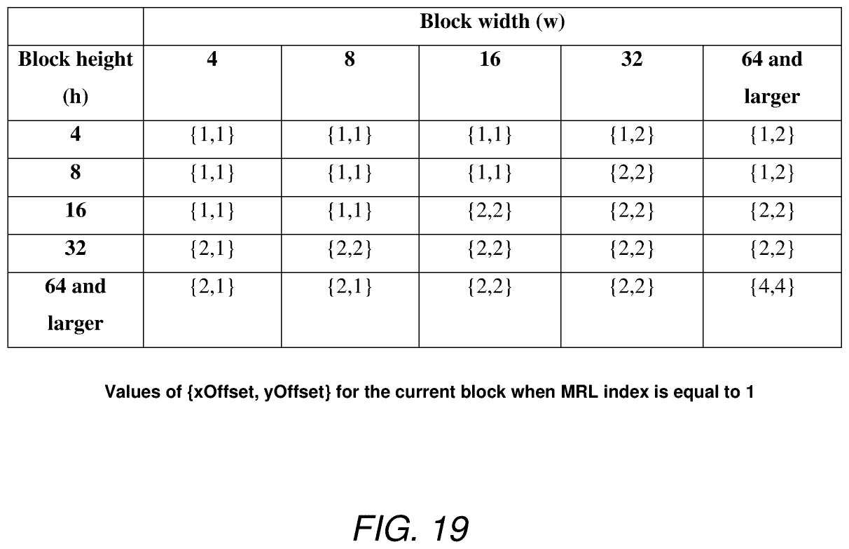

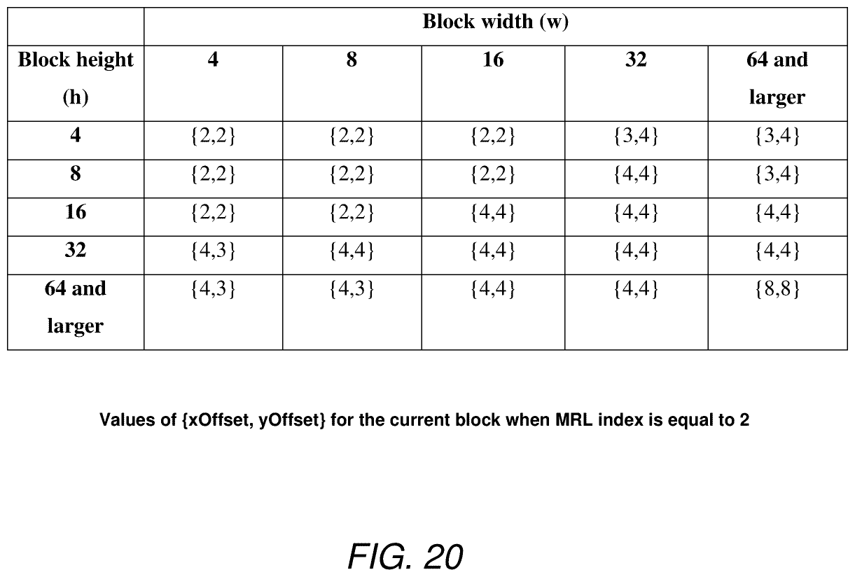

In yet another example, the encoder may use both the height (h) and the width (w) of current block 1802 to determine the horizontal reference line offset and the vertical reference line offset. For example, the encoder may determine the horizontal reference line offset and the vertical reference line offset for reference lines 1 and 2 according to a correspondence table. For example, the encoder may determine the horizontal reference line offset and the vertical reference line offset for reference lines 1 and 2 according to the correspondence tables shown in FIGS. 19 and 20, respectively. Reference line 0 may be determined to have a horizontal and a vertical reference line offset equal to 0 in all instances. In other words, the horizontal reference line offset and the vertical reference line offset of reference line 0 may not depend on a property of current block 1802 and may be equal to 0 in all instances. In other examples, a similar correspondence table to those for reference lines 1 and 2 may be provided for reference line 0.

In accordance with the correspondence table shown in FIG. 19, the encoder may determine the horizontal reference line offset (xOffset) and the vertical reference line offset (yOffset) for reference line 1 to be 2 and 1, respectively, based on the height (h) of current block 1802 being equal to 32 and the width (w) of current block 1802 being equal to 4. In another example and in accordance with the correspondence table shown in FIG. 19, the encoder may determine the horizontal reference line offset (xOffset) and the vertical reference line offset (yOffset) for reference line 1 to be 1 and 2, respectively, based on the height (h) of current block 1802 being equal to 4 and the width (w) of current block 1802 being equal to 32. These are two examples where asymmetric reference line offsets are determined for reference line 1 based on the height (h) and width (w) of current block 1802. In other examples, symmetric reference line offsets may be determined for reference line 1 based on the height (h) and width (w) of current block 1802 having other particular values as shown by the correspondence table in FIG. 19.

In accordance with the correspondence table shown in FIG. 20, the encoder may determine the horizontal reference line offset (xOffset) and the vertical reference line offset (yOffset) for reference line 2 to be 4 and 3, respectively, based on the height (h) of current block 1802 being equal to 32 and the width (w) of current block 1802 being equal to 4. In another example and in accordance with the correspondence table shown in FIG. 20, the encoder may determine the horizontal reference line offset (xOffset) and the vertical reference line offset (yOffset) for reference line 2 to be 3 and 4, respectively, based on the height (h) of current block 1802 being equal to 4 and the width (w) of current block 1802 being equal to 32. These are two examples where asymmetric reference line offsets are determined for reference line 2 based on the height (h) and width (w) of current block 1802. In other examples, symmetric reference line offsets may be determined for reference line 2 based on the height (h) and width (w) of current block 1802 having particular values as shown by the correspondence table in FIG. 20.

In yet another example, the encoder may use one or more formulas to determine a horizontal reference line offset and a vertical reference line offset for a reference line. For example, the encoder may use the following formulas to determine a horizontal reference line offset and a vertical reference line offset for a reference line:

$$xOffset = M [ ( {log}_{2} ( w ) - 2 + {log}_{2} ( h ) - 2 ) ≫ 1 ] + {δ}_{W} \qquad ( 25 )$$

$$yOffset = M [ ( {log}_{2} ( w ) - 2 + {log}_{2} ( h ) - 2 ) ≫ 1 ] + {δ}_{H} \qquad ( 26 )$$

$${δ}_{W} = \{ \begin{matrix}- 1 , & when \frac{w}{h} \geq 4 \\ 0 , & otherwise\end{matrix} , {δ}_{H} = \{ \begin{matrix}- 1 , & when \frac{h}{w} \geq 4 \\ 0 , & otherwise\end{matrix} \qquad ( 27 )$$

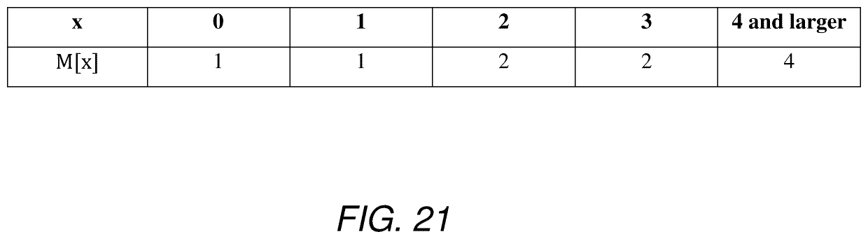

Mapping function M [⋅] may be determined based on the table shown in FIG. 21. A different mapping function M [⋅] may be determined and used for one or more reference lines. For example, the mapping function M [⋅] of FIG. 21 may be provided for reference line 2. A separate mapping function M [⋅] may be provided for reference line 1 or 0. In addition, the constants in equations (25)-(27) may be changed from those shown above to any other reasonable constant value or additional constants may be added to the formulas without departing from the scope or spirit of the present disclosure.

Referring back to the actual example illustrated in FIG. 18, the encoder determines symmetric reference line offsets for both reference line 0 and reference line 1 in accordance with one more of the approaches discussed above. More specifically, the encoder determines: the horizontal and the vertical reference line offset for reference line 0 to both be 0; and the horizontal and the vertical reference line offset for reference line 1 to both be 1. For reference line 2, the encoder determines asymmetric reference line offsets in accordance with one or more of the approaches discussed above (e.g., based on a correspondence table similar to those shown in FIG. 19 and FIG. 20 or formulas similar to (25) and (26)). More specifically, the encoder determines a horizontal reference line offset (xOffset) 1804 equal to 3 samples and a vertical reference line offset (yOffset) 1806 equal 2 samples as shown in FIG. 18.

The encoder may determine samples of the reference line based on the horizontal reference line offset and the vertical reference line offset of the reference line. Each reference line n (n>0) in the example of FIG. 18, may comprise a sample segment E with 2w samples in the row yOffset-samples above the topmost row of current block 1802 (where yOffset is again the vertical reference line offset of the reference line), a sample segment B with 2h samples in the column xOffset-samples to the left of the left-most column of current block 1802 (where xOffset is again the horizontal reference line offset of the reference line), sample segments D and F (except for yOffset=0) with samples respectively to the left and right of segment E, sample segments A and C (except for xOffset=0) with samples respectively below and above segment B, and a neighboring corner sample shown with hatching. The reference lines may further have additional sample segments to the left or below the neighboring corner sample depending on a difference between the reference line offsets. Each reference line in FIG. 18 is marked with a dashed line.

The samples in the reference lines may come from reconstructed samples of neighboring blocks of current block 1802. In one embodiment, the samples of segments A and F may, instead of coming from reconstructed samples, be padded with the closest samples available from segments B and E, respectively.

The encoder may predict each sample of current block 1802 by projecting the location of the sample in current block 1802 in a given direction specified by an intra prediction mode to a point (referred to herein as a “projection point”) on the horizontal line or the vertical line of one of reference lines 0-2. FIG. 18 illustrates an example projection of a location [x] [y] of a sample in current block 1802. The encoder may project the location [x] [y] in a direction 1808 specified by a vertical intra prediction mode. Direction 1808 may be given by an angle q defined relative to the y-axis for the vertical prediction mode. In other examples, a horizontal intra prediction mode may be used, in which case the angle q may be defined relative to the x-axis. The location [x] [y] may be projected to a projection point 1810 on the horizontal line of reference line 0, a projection point 1812 on the horizontal line of reference line 1, or a projection point 1814 on the horizontal line of reference line 2. If the projection point falls directly on a reference sample of the reference line to which it was projected, the value of the reference sample may be used as the predicted value for the sample. If the projection point falls at a fractional sample position between two reference samples on the reference line to which it was projected, the encoder may apply an interpolation filter to one or more of the reference samples available at integer sample positions on each side of the projection point. The interpolation filter may filter the reference samples to interpolate a value at the fractional sample position of the projection point. For example, a two-tap interpolation filter may be used for chroma samples and a four-tap interpolation filter may be used for luma samples. The encoder may determine the predicted sample value based on the interpolated value. The encoder may determine a prediction error for current block 1802 based on a difference (e.g., sum of squared differences (SSD), sum of absolute differences (SAD), or sum of absolute transformed differences (SATD) between the predicted samples, determined for the given intra prediction mode and reference line as explained above, and the original samples of current block 1802.

The encoder may perform this process of predicting samples and determining a prediction error, based on a difference between the predicted samples and original samples, for a plurality of different combinations of intra prediction modes and reference lines. For example, the encoder may perform this process for each combination of the 67 intra prediction modes in VVC, including non-angular (e.g., DC and planar) intra prediction modes, and reference lines 0-2. With 67 intra prediction modes and 3 reference lines, there are a total of 67*3 or 201 different intra prediction mode and reference line combinations. Thus, the encoder will determine a total of 67*3 or 201 predictions and prediction errors of current block 1802 if all such combinations are tested. In ECM, over 100 intra prediction modes are under exploration for inclusion in the next video compression standard.

The encoder may select an intra prediction mode and reference line combination to encode current block 1802 based on the determined prediction errors. For example, the encoder may select an intra prediction mode and reference line combination that results in the smallest prediction error for current block 1802. In another example, the encoder may select the intra prediction mode and reference line combination to encode current block 1802 based on a rate-distortion measure determined using the prediction errors. The encoder may send an indication of a selected intra prediction mode, a selected reference line, and a corresponding prediction error for the selected intra prediction mode and selected reference line combination to a decoder for decoding of current block 1802. The encoder may send the indication of the selected reference line by signaling the index of the reference line. For example, the encoder may send index 2 in the bitstream for current block 1802 based on the encoder selecting reference line 2 as the selected reference line.

Angular intra prediction using multiple reference lines may be performed in the same manner as described above with respect to FIG. 17 except that the equations described above with respect to FIG. 17 may be generalized for a reference line with any horizontal reference line offset (xOffset) and vertical reference line offset (yOffset), including asymmetric reference lines offsets. For example, equations (19) and (20), which may be used to simplify the prediction process by placing what may be referred to as the main reference samples in two, one-dimensional arrays, may be rewritten as:

$$r e {f}_{1} [ x ] = p [ - 1 + x - xOffset ] [ - 1 - yOffset ] , ( x \geq 0 ) \qquad ( 28 )$$

$$re {f}_{2} [ y ] = p [ - 1 - xOffset ] [ - 1 + y - yOffset ] , ( y \geq 0 ) \qquad ( 29 )$$

where xOffset is the horizontal reference line offset of the reference line used for intra prediction and yOffset is the vertical reference line offset of the reference line used for intra prediction. In addition, equations (21) and (22) for determining the integer and fractional part of the displacement for vertical intra prediction modes may be rewritten as:

$${i}_{i} = ⌊ ( y + 1 + yOffset ) \cdot tan φ ⌋ , \qquad ( 30 )$$

$${i}_{f} = ( ( y + 1 + yOffset ) \cdot tan φ ) - ⌊ ( y + 1 + yOffset ) \cdot tan φ ⌋ . \qquad ( 31 )$$

and equations (23) and (24) for determining the integer and fractional part of the displacement for horizontal intra prediction modes may be rewritten as:

$${i}_{i} = ⌊ ( x + 1 + xOffset ) \cdot tan φ ⌋ , \qquad ( 32 )$$

$${i}_{f} = ( ( y + 1 + xOffset ) \cdot tan φ ) - ⌊ ( x + 1 + xOffset ) \cdot tan φ ⌋ . \qquad ( 33 )$$

Equations 28-33 provide exemplary means for performing angular intra prediction using multiple reference lines with any horizontal reference line offset (xOffset) and vertical reference line offset (yOffset), including asymmetric reference line offsets. In other examples, different equations may be used to perform angular intra prediction.

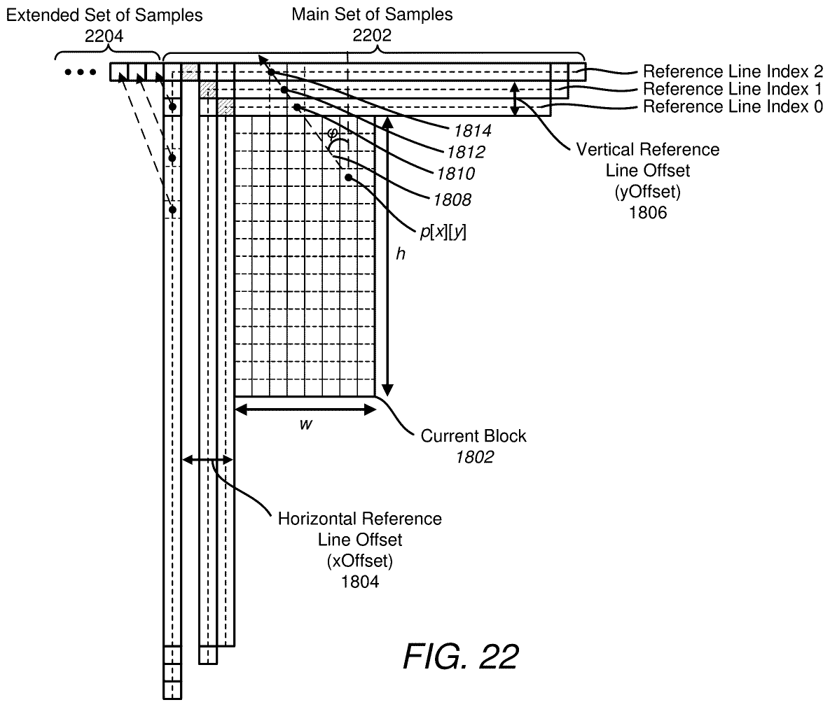

It should be noted that, in addition to the main reference samples of a reference line, the encoder may determine or construct what may be referred to as extended reference samples of the reference line for the case where the position [x] [y] of a sample in current block 1802 to be predicted is projected to a negative index of the ref₁ [x] array, which happens with negative vertical prediction angles q. The encoder may determine or construct the extended reference samples by projecting the reference samples in one or more of the column segments A, B, and C of the reference line to extend the row (or row segments) of the reference line to the left using the negative vertical prediction angle q. FIG. 22 illustrates an example extended set of samples 2204 determined or constructed as discussed above. As shown in FIG. 22, samples of the one or more column segments A, B, and C of reference line 2 are projected, using the negative vertical prediction angle q, to extend the row (or row segments) of the reference line to the left. Extended set of samples 2204 may be determined and further placed in the one-dimensional array ref₁ [x] as follows:

$$r e {f}_{1} [ x ] = p [ - 1 - xOffset ] [ - 1 - yOffset + Min ( ⌊ x \cdot cot φ ⌋ , h ) ] , ( x < 0 ) \qquad ( 34 )$$

where cot is the trigonometric cotangent function and h is the height of current block 1802.

The encoder may similarly determine or construct extended reference samples of the reference line for the case where the position [x] [y] of a sample in current block 1802 to be predicted is projected to a negative index of the ref₂ [y] array, which happens with negative horizontal prediction angles q. The encoder may determine or construct the extended reference samples by projecting the reference samples in one or more of the row segments D, E, and F of the reference line to extend the column (or column segments) of the reference line upwards using the negative horizontal prediction angle q. The extended set of samples may be determined and further placed in the one-dimensional array ref₂ [y] as follows:

$$r e {f}_{2} [ y ] = p [ - 1 - xOffset + Min ( ⌊ y \cdot cot φ ⌋ , w ) ] [ - 1 - yOffset ] , ( y < 0 ) \qquad ( 35 )$$

where cot is the trigonometric cotangent function and w is the width of current block 1802.

It should be noted that, although the example intra prediction of FIG. 18 was described above as being performed at an encoder, a decoder may also perform a similar intra prediction. For example, a decoder may receive, from an encoder for a block, an indication of an intra prediction mode, an indication of a reference line from a plurality of reference lines (e.g., reference lines 0-2 in FIG. 18 or those tested by the encoder during intra prediction), and a residual. The decoder may construct the indicated reference line and perform intra prediction based on the indicated intra prediction mode for the block in a similar manner as discussed above for the encoder. For example, the decoder may determine the horizontal reference line offset (xOffset) and the vertical reference line offset (yOffset) of the indicated reference line in the same or similar manner as described above with respect to the encoder. The decoder may use the horizontal reference line offset and the vertical reference line offset to determine or construct the samples of the reference line (including the main and extended set of reference samples) in the same or similar manner as described above with respect to the encoder. The decoder may then project the locations of samples in the current block to the reference samples to determine predicted values as described above with respect to the encoder. The decoder may add the predicted values of the samples of the block to the residual to reconstruct the block. In an embodiment, the decoder may not receive one or both of the indication of the intra prediction mode and the indication of the reference line from the encoder for the block. Instead, the decoder may determine one or both of the intra prediction mode and reference line through other means, such as decoder side means.

Although the use of multiple reference lines may increase coding gain, the complexity of the encoder also increases because the additional lines need to be tested during intra prediction. To reduce encoder complexity, the additional reference lines may be only tested for a subset of the intra prediction modes, such as those in a most probable mode (MPM) list. The MPM list may be adaptively generated for current block 1802 based on, for example, the availability and indices of intra prediction modes of the top and left neighboring blocks of current block 1802. The MPM list may be constructed in accordance with HEVC, VVC, or any other video coding standard. Moreover, the planar and DC intra prediction modes may be only applied to the reference line directly adjacent to current block 1802 (i.e., reference line 0) to further reduce encoder complexity. In such a case, a separate angular mode only MPM list may be constructed that includes only angular intra prediction modes. The additional reference lines may be only tested for the intra prediction modes in the angular mode only MPM list when such a list is used.

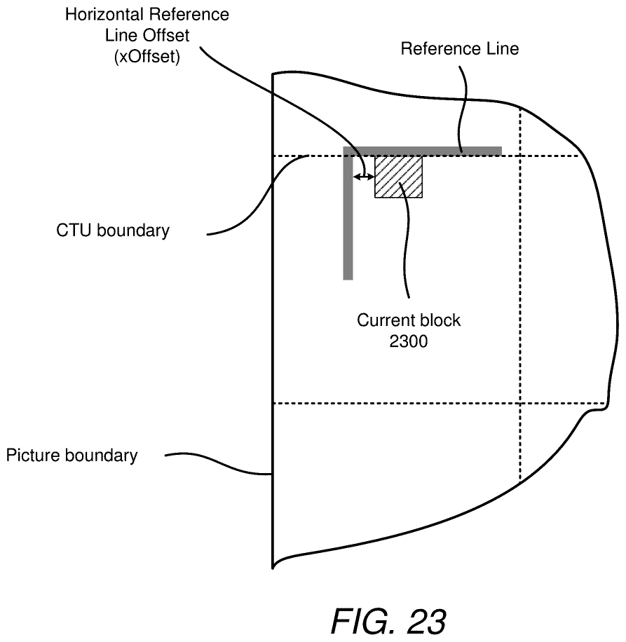

FIG. 23 illustrates an example in which asymmetric reference line offsets may be used based on the position of a current block 2300 relative to a coding tree unit (CTU) boundary between two CTUs in accordance with embodiments of the present disclosure. In the example of FIG. 23, current block 2300 is being encoded or decoded using intra prediction. In existing technologies, when the top row of samples of a current block is directly adjacent to a top boundary of the CTU that the current block is located within, intra prediction of current block 2300 is limited to reference line 0 with horizontal and vertical reference line offsets both equal to 0. This is because reference samples above the CTU of current block 2300 are generally not available to a decoder except the samples in the first row above the CTU, which are stored in a line buffer. However, with asymmetric reference line offsets as explained above with respect to FIG. 18, intra prediction of current block 2300 does not need to be so limited.

In an example, an encoder or decoder may determine, based on a position of current block 2300 relative to the boundary of the CTU that block 2300 is located within, a vertical reference line offset (yOffset) of a reference line for performing intra prediction of current block 2300. For example, based on the top row of samples of current block 2300 being directly adjacent to the top boundary of the CTU, the vertical reference line offset may be set to a predetermined value. For example, the predetermined value may be zero as shown in the example of FIG. 23. The predetermined value may be determined based on samples outside of the CTU that are available as reference samples for performing intra prediction of current block 2300.

In an example, the encoder or decoder may further determine a horizontal reference line offset (xOffset) of the reference line for performing intra prediction of current block 2300. For example, the encoder or decoder may determine the horizontal reference line offset based on an index of the reference line. For example, the encoder or decoder may determine the horizontal reference line offset to be equal to the index of the reference line. In another example, the encoder or decoder may determine the horizontal reference line offset based on a property of current block 2300 as explained above with respect to FIG. 18. For example, the encoder or decoder may determine the horizontal reference line offset based on a height, a width, both a height and a width, or an aspect ratio of current block 2300. In another example, the encoder or decoder may determine the horizontal reference line offset based on a correspondence table or formulas as explained above with respect to FIG. 18. The vertical reference line offset determined based on a correspondence table may be ignored or overridden based on the top row of samples of current block 2300 being directly adjacent to the top boundary of the CTU.

After the horizontal and vertical reference line offsets of the reference line are determined, the encoder or decoder may determine samples of the reference line based on the offsets as explained above with respect to FIG. 18. The encoder or decoder may then use the samples and an intra prediction mode to predict current block 2300 as further explained above with respect to FIG. 18.

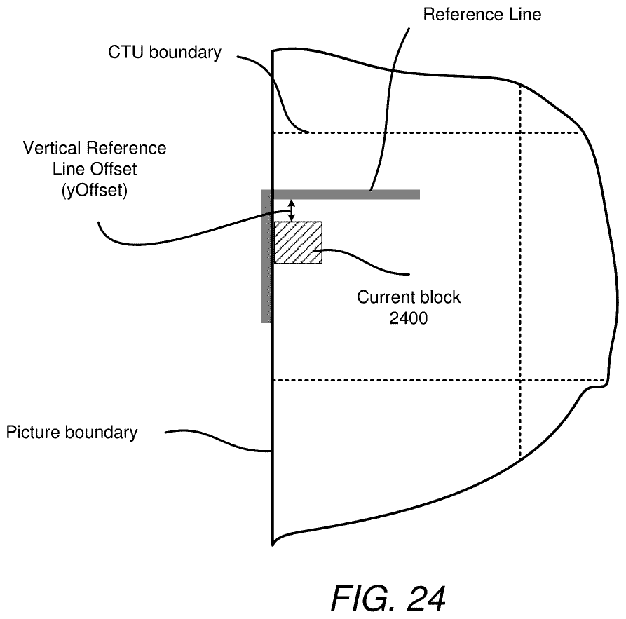

FIG. 24 illustrates an example in which asymmetric reference line offsets may be used based on the position of a current block 2400 relative to a picture boundary in accordance with embodiments of the present disclosure. In the example of FIG. 24, current block 2400 is being encoded or decoded using intra prediction. Because the left most column of samples of current block 2400 is directly adjacent to a left boundary of the picture that current block 2400 is located within, the one or more column segments of a reference line used to perform intra prediction will be positioned outside of the picture boundary and therefore not available. In such a case, it may be beneficial for the one or more column segments of the reference line to be positioned as close to the picture boundary as possible. In existing technologies, only reference line 0 provides such positioning of the one or more column segments. However, with asymmetric reference line offsets as explained above with respect to FIG. 18, intra prediction of current block 2400 does not need to be so limited.

In an example, an encoder or decoder may determine, based on a position of current block 2400 relative to the boundary of the picture the current block 2400 is located within, a horizontal reference line offset (xOffset) of a reference line for performing intra prediction of current block 2400. For example, based on the left most column of samples of current block 2400 being directly adjacent to the left boundary of the picture, the horizontal reference line offset may be set to a predetermined value. For example, the predetermined value may be zero as shown in the example of FIG. 24. The predetermined value may be determined to position the one or more column segments of the reference line to be as close to the picture boundary as possible.

In an example, the encoder or decoder may further determine a vertical reference line offset (yOffset) of the reference line for performing intra prediction of current block 2400. For example, the encoder or decoder may determine the vertical reference line offset based on an index of the reference line. For example, the encoder or decoder may determine the vertical reference line offset to be equal to the index of the reference line. In another example, the encoder or decoder may determine the vertical reference line offset based on a property of current block 2400 as explained above with respect to FIG. 18. For example, the encoder or decoder may determine the vertical reference line offset based on a height, a width, both a height and a width, or an aspect ratio of current block 2400. In another example, the encoder or decoder may determine the vertical reference line offset based on a correspondence table or formulas as explained above with respect to FIG. 18. The horizontal reference line offset determined based on a correspondence table may be ignored or overridden based on the left most column of samples of current block 2400 being directly adjacent to the left boundary of the picture.

After the horizontal and vertical reference line offsets of the reference line are determined, the encoder or decoder may determine samples of the reference line based on the offsets as explained above with respect to FIG. 18. The encoder or decoder may then use the samples and intra prediction mode to predict current block 2400 as further explained above with respect to FIG. 18.

It should be noted that instead of the boundary in FIG. 24 being a picture boundary, the boundary may be tile or slice boundary in other examples.

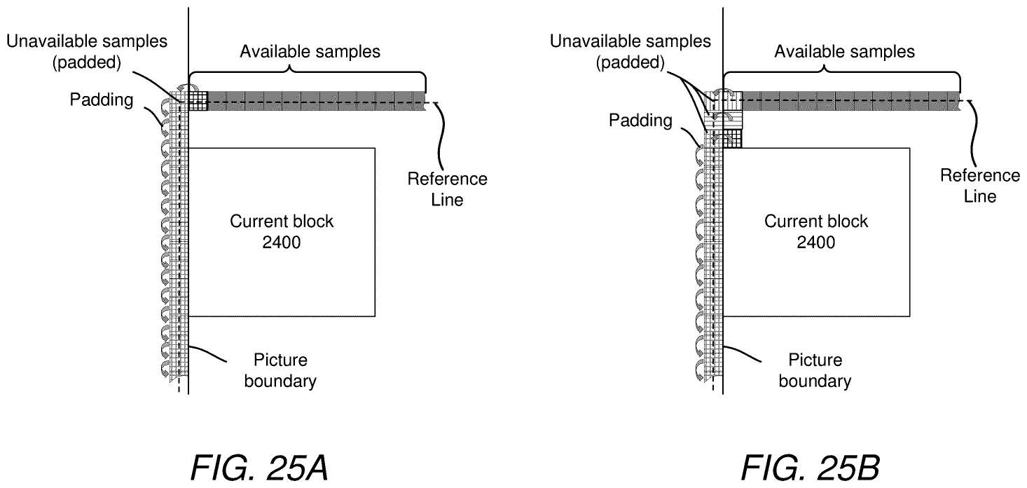

FIG. 25A illustrates an example reference sample substitution (or padding) of unavailable samples of the reference line shown in FIG. 24. As can be seen from FIG. 25A, the reference samples in the one or more column segments of the reference line that are outside of the picture boundary are unavailable for prediction. FIG. 25A shows the existing technology approach for substituting the unavailable reference samples. More specifically, as shown in FIG. 25A, the unavailable reference samples are substituted by scanning the reference samples in the clock-wise direction and using the latest available reference sample for substitution. In FIG. 25A, the unavailable reference samples in the one or more column segments of the reference line that are outside of the picture boundary are substituted by the latest available sample in the row of the reference line when scanning the reference samples in clock-wise direction.

It should be noted that instead of the boundary in FIG. 25A being a picture boundary, the boundary may be tile or slice boundary in other examples.

FIG. 25B illustrates another example reference sample substitution (or padding) of unavailable samples of the reference line shown in FIG. 24 in accordance with embodiments of the present disclosure. As can be seen from FIG. 25B, the reference samples in the one or more column segments of the reference line that are outside of the picture boundary are unavailable for prediction. FIG. 25B shows an approach for substituting the unavailable reference samples that may provide better prediction results of current block 2400 based on the reference line. More specifically and as shown in FIG. 25B, the unavailable reference samples may be substituted by replacing each unavailable reference sample with the sample to the right of the unavailable sample if available. If the sample to the right of the unavailable reference sample is not available (e.g., because it is located within current block 2400), the unavailable reference sample may be substituted by scanning the reference samples (including previously substituted reference samples) in clock-wise direction and using the latest available reference sample for substitution. Substitution of unavailable reference samples may be performed in clock-wise order.

It should be noted that instead of the boundary in FIG. 25B being a picture boundary, the boundary may be tile or slice boundary in other examples.

In an embodiment, a correspondence between indicated MRLP index and a distance from a predicted block to a reference line may be defined based on the position of a block inside a CTU.

For example, a set of distances for multiple reference lines used in MRLP is defined as follows:

$${s}_{i} = \{ 0 , 1 , 3 , 5 , 7 , 12 \} , i = 0 … 5$$

An index ‘mrlIdx’ is indicated in a bitstream so that prediction of a block is performed based on a reference line which has an offset—(S_{mrlIdx}+1) in either the vertical or horizontal direction with respect to the top-left corner of the block. Each distance represents the distance from the block (i.e., from either a top most row or left most column of the block) to the reference line with the corresponding index ‘mrlIdx’.

In another embodiment, the larger values of i may correspond to smaller values of distance, i.e, a set of distances for multiple reference lines used in MRLP will be defined in a non-monothonic way.

In another embodiment, a set of distances for multiple reference lines used in MRLP to predict a block may be defined based on the size of the block. An example is given in Table 1 below:

TABLE 1
Correspondence of block size and the set of MRLP line distances

| Block size | A set of MRLP lines distances sᵢ |
|---|---|
| Less than 256 samples | {0, 1, 3, 5, 7, 12} |
| Greater than or equal to 256 samples | {0, 3, 5, 7, 12, 1} |

In another example, a maximum indicated index is equal to 4, meaning that 5 reference lines are available for performing MRLP. Examples of how distance may be determined in such a case are shown in Tables 2 and 3 below:

TABLE 2
Example of MRLP line distance determination
based on a block size

| Block size | A set of MRLP lines distances sᵢ |
|---|---|
| Less than 256 samples | {0, 1, 3, 5, 7} |
| Greater than or equal to 256 samples | {0, 3, 5, 7, 12} |

TABLE 3
Example of MRLP line distance determination
based on a block size

| Block size | A set of MRLP lines distances sᵢ |
|---|---|
| Less than 256 samples | {0, 1, 2, 4, 7} |
| Greater than or equal to 256 samples | {0, 2, 4, 7, 12} |

In the examples shown in Tables 2 and 3, the smaller blocks have a distance equal to 1, while for larger blocks such a small distance is not specified.

Another example relates to the properties of mode derivation procedure performed, e.g., by Template Intra Mode Derivation (TIMD). When deriving a mode, reference samples are used based on the size of the template area. When MRL is in effect, a set of MRLP line distances sᵢ may be defined in such a way that the width and the height of the templates are included into the set sᵢ. A particular example is shown in Table 4 below:

TABLE 4
Dependency of MRL line distance on TIMD flag

| TIMD flag | A set of MRLP lines distances sᵢ |
|---|---|
| 0 | {0, 1, 3, 5, 7, 12} |
| 1 | {0, 1, 2} |

It should be noted that Table 3 has the TIMD harmonization distinctive feature, since it includes distances corresponding to the side lengths of TIMD templates which may be equal to 2 or to 4.

Another example is shown in Table 5 below:

TABLE 5
Dependency of MRL line distance on TIMD flag

| TIMD flag | A set of MRLP lines distances sᵢ |
|---|---|
| 0 | {0, 1, 3, 5, 7, 12} |
| 1 | {0, 2, 4} |

In an example, when TIMD flag is 1, selection of the set of MRLP lines distances may be performed based on the width or the height of the template. When the width of the left TIMD template is equal to 2 the set sᵢ={0, 1, 2} is used for the horizontal distance to MRL reference line (xOffset). When the width of the left TIMD template is equal to 4 the set sᵢ={0, 2, 4} is used for horizontal displacement (xOffset).

Correspondingly, when the height of the above TIMD template is equal to 2 the set sᵢ={0, 1, 2} is used for the vertical distance to MRL reference line (yOffset). When the height of the above TIMD template is equal to 4 the set sᵢ={0, 2, 4} is used for the vertical distance to MRL reference line (yOffset).

Width and height of a TIMD template depends on the width and height of a predicted block. Hence, the above design could be reformulated as follows:

When TIMD flag is 1, selection of the set of MRLP lines distances may be performed based on the width or the height of the predicted block. When the width of the block is less or equal to 8 the set sᵢ={0, 1, 2} is used to obtain for the horizontal distance to MRL reference line (xOffset). Otherwise, sᵢ={0, 2, 4} is used to obtain horizontal displacement (xOffset).

Correspondingly, when the height of the block is less or equal to 8 the set sᵢ={0, 1, 2} is used to obtain the vertical distance to MRL reference line (yOffset). Otherwise, the set sᵢ={0, 2, 4} is used to obtain the vertical distance to MRL reference line (yOffset).

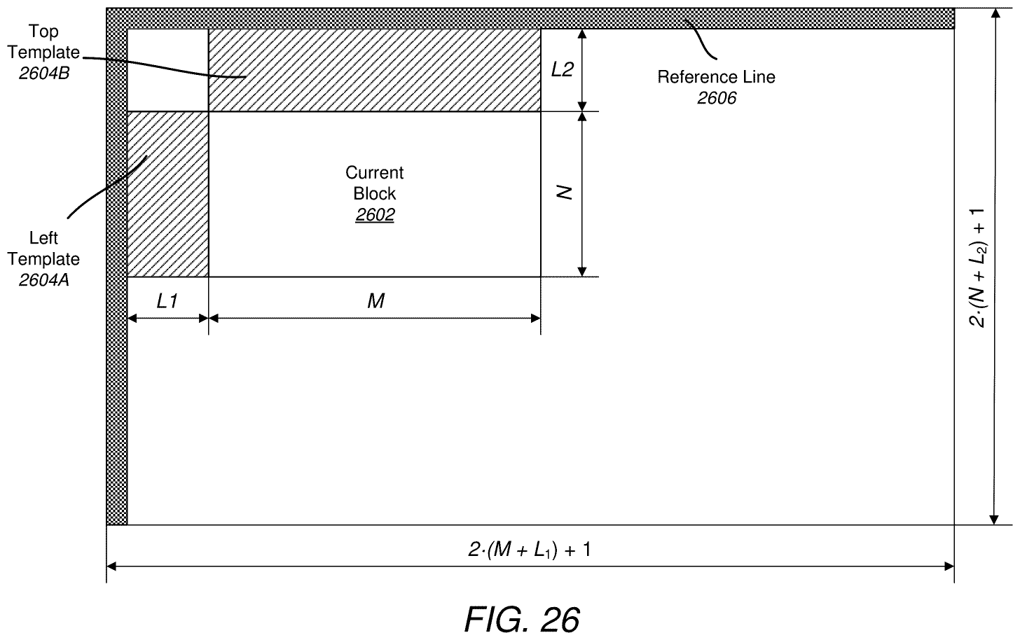

Referring now to FIG. 26, an example implementation of TIMD in accordance with embodiments of the present disclosure is illustrated. The implementation of TIMD in FIG. 26 may be implemented at both an encoder and decoder, such as encoder 200 in FIG. 2 and decoder 300 in FIG. 3.

In FIG. 26, the encoder and decoder may derive an intra prediction mode for a current block 2602 using TIMD. Current block 2602 may be a block within a picture or frame. For example, current block 2602 may be a CU within a CTU of a picture. To derive the intra prediction mode for current block 2602, TIMD may determine a template comprising reconstructed neighboring samples of current block 2602. The template may comprise a left template 2604A and a top template 2604B that extend to the left and above current block 2602 by L1 and L2 samples, respectively. For example, left and top templates 2604A and 2604B may have a lengths L1=L2=2 for current block 2602 of size 4×4 or 8×8 and a length L1=L2=4 for current block 2602 of size 16×16 or larger. In another example, L1 and L2 may be determined by the length of the same or different sides of current block 2602. For example, L1 may be determined based on a width of current block 2602 or a height of current block 2602. L2 may be determined based on a width of current block 2602 or a height of current block 2602.

The encoder and decoder may further determine a reference line 2606 of left and top templates 2604A and 2604B. Reference line 2606 comprises neighboring samples above and to the left of current block 2602. The samples in reference line 2606 may not always come from reconstructed samples. Instead, a reference sample substitution algorithm may be used to determine unavailable samples in reference line 2606 from available reference samples.

For each of a plurality of intra prediction modes, the encoder and decoder may generate a prediction of left and top templates 2604A and 2604B from reference line 2606. For example, the encoder and decoder may generate a prediction of left and top templates 2604A and 2604B from reference line 2606 in a same or similar manner as reference samples 902 were used to generate a prediction of current block 904 as described above with respect to FIGS. 11 and 12 above. In an embodiment, the plurality of intra prediction modes for which the encoder and decoder generate a prediction of left and top templates 2604A and 2604B from reference line 2606 may comprise only intra prediction modes that are included in one or more MPM lists constructed for intra prediction of current block 2602. The one or more MPM lists may be adaptively generated for current block 2602 based on, for example, the availability and indices of intra prediction modes of the top and left neighboring blocks of current block 2602 and/or other sources, such as an index of a DIMD intra prediction mode as will be explained further below. The one or more MPM lists may be constructed in accordance with HEVC, VVC, ECM or any other video coding standard or algorithm.

In an embodiment, TIMD may be configured to generate a prediction of left and top templates 2604A and 2604B from reference line 2606 for a greater number of angular intra prediction modes than the precision of entries in the one or more MPM lists permits. For example, TIMD may be configured to generate a prediction of left and top templates 2604A and 2604B from reference line 2606 for 129 angular intra prediction modes and the precision of entries in the one or more MPM lists may only permit an indication of one of the 65 angular intra prediction mode described in the VVC standard. In an embodiment, the encoder and decoder may generate multiple predictions of left and top templates 2604A and 2604B from reference line 2606 for each intra prediction mode (or some subset) indicated in the one or more MPM lists at the lower precision. For example, for each intra prediction mode (or some subset) indicated in the one or more MPM lists, the encoder and decoder may generate a prediction of left and top templates 2604A and 2604B from reference line 2606 for the intra prediction mode indicated in the one or more MPM lists as well as a prediction of left and top templates 2604A and 2604B from reference line 2606 for one or more neighboring intra prediction modes to the intra prediction mode in the MPM list. The one or more neighboring intra prediction modes may correspond to intra prediction modes not indicated or included in the one or more MPM lists due to the precision limitation of entries in the one or more MPM list.

For each generated prediction, the encoder and decoder may then determine a prediction error based on a difference (e.g., sum of squared differences (SSD), sum of absolute differences (SAD), or sum of absolute transformed differences (SATD)) between the prediction samples determined for the intra prediction mode and the reconstructed samples of left and top templates 2604A and 2604B. The encoder and decoder may select an intra prediction mode from the applied intra prediction modes based on the determined prediction errors. For example, the encoder and decoder may select an intra prediction mode from the applied intra prediction modes that results in the smallest prediction error for left and top templates 2604A and 2604B. The selected intra prediction mode may be referred to as the “TIMD intra prediction mode” and may be selected from the larger set of intra prediction modes (e.g., the set of 129 angular intra prediction modes) available to TIMD. It should be noted that other selection criteria may be used to select an intra prediction mode from the applied intra prediction modes. In another example, the encoder and decoder may select the two intra prediction modes, from the applied intra prediction modes, that result in the first and second smallest predictions errors for left and top templates 2604A and 2604B in a process referred to as “TIMD fusion.” The encoder and decoder may use the two intra prediction modes by predicting current block 2602 using each of the two intra prediction modes and computing a final predictor based on a weighted average of each prediction determined using the two intra prediction modes. The weights applied to each prediction may be determined based on a cost factor corresponding to the intra prediction mode used to determine the prediction.

The encoder may compare a rate-distortion (RD) cost of encoding current block 2602 with the TIMD intra prediction mode and other intra prediction modes and select an appropriate intra prediction mode to encode current block 2602 (e.g., the intra prediction mode with a lowest RD cost). Based on the encoder selecting the TIMD intra prediction mode to encode current block 2602, the encoder may signal a TIMD flag indicating that the TIMD intra prediction mode as the intra prediction mode used to encode current block 2602. Based on sending the TIMD flag, the encoder may not transmit other syntax elements used to code the intra prediction of current block 2602, such as an MPM flag, an MPM index, or a truncated binary code for a non-MPM intra prediction mode. The decoder may parse the TIMD flag in a bitstream received from the encoder. Based on the TIMD flag indicating the TIMD intra prediction mode as the selected intra prediction mode used to encode current block 2602, the decoder may perform TIMD as discussed above to independently derive the TIMD intra prediction mode and predict current block 2602.

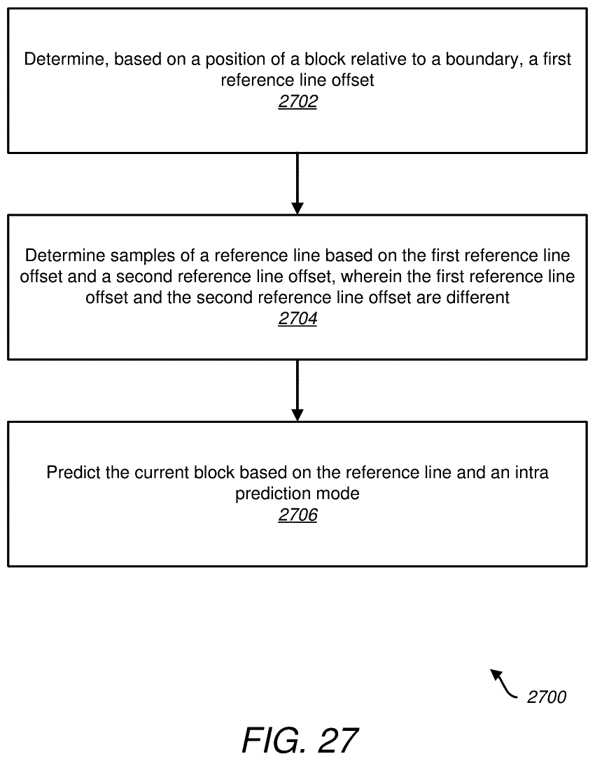

FIG. 27 illustrates a flowchart 2700 of a method for determining a prediction of a sample based on a reference line offset in accordance with embodiments of the present disclosure. The method of flowchart 2700 may be implemented by an encoder or a decoder, such as encoder 200 in FIG. 2 or decoder 300 in FIG. 3.

The method of flowchart 2700 begins at 2702. At 2702, a first reference line offset is determined based on a position of a block relative to a boundary.

In an example, the boundary is one of a boundary of the picture that the block is located within, a boundary of the CTU that the block is located within, or a boundary of the tile that the block is located within. In an example, the boundary is one of a top boundary or a left boundary.

In an example, the first reference line offset is set to a predetermined offset value based on a top row or left column of samples of the block being directly adjacent to the boundary. In an example, the predetermined off set value is zero. In an example, the boundary is a top boundary, the first reference line offset is a vertical reference line offset, and the second reference line offset is a horizontal reference line offset. In another example, the boundary is a left boundary, the first reference line offset is a horizontal reference line offset, and the second reference line offset is a vertical reference line offset.

At 2704, samples of a reference line are determined based on the first reference line offset and a second reference line offset, where the first reference line offset and the second reference line offset are different.

In an example, determining the samples of the reference line comprises determining a main set of samples of the reference line and determining an extended set of samples of the reference line. The main set of samples of the reference line are determined based on the first reference line offset or the second reference line offset. The extended set of samples of the reference line are determined based on the first reference line offset and the second reference line offset. In an example, the one of the first reference line offset or the second reference line offset is determined based on the intra prediction mode.

In an example, the second reference line offset is determined based on a reference line index.

In an example, the second reference line offset is determined based on a property of the block. In an example, the property of the block is at least one of a height of the block or a width of the block. In another example, the property of the block is an aspect ratio of the block.

At 2706, the current block is predicted based on the reference line and an intra prediction mode.

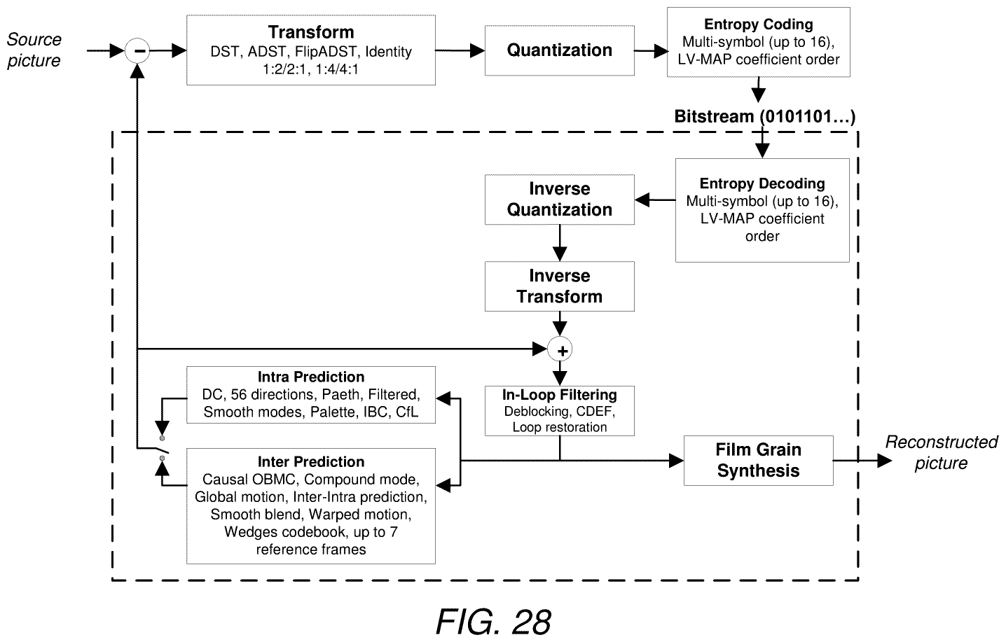

Similar to VVC/H.266, MRLP is considered a candidate for adopting it into the AOM's AV2 codec. There, it is known as “Multiple Reference Line Selection for intra prediction (MRLS)” uses up to 4 reference lines. Like done in VVC, MRLS is only applied to the luma component, since chroma texture is relatively smooth. In contrast to VVC where MRLP is enabled for DC mode, MRLS is disabled for any non-directional intra prediction mode. Similar to VVC/H.266, reference line selection is signaled into the bitstream. Thus, the above mentioned embodiments are applicable in case of the new AOM's video codec as well shown in FIG. 28. In particular, described embodiments are applicable within steps “Intra prediction”, “Entropy coding” and “Entropy decoding”.

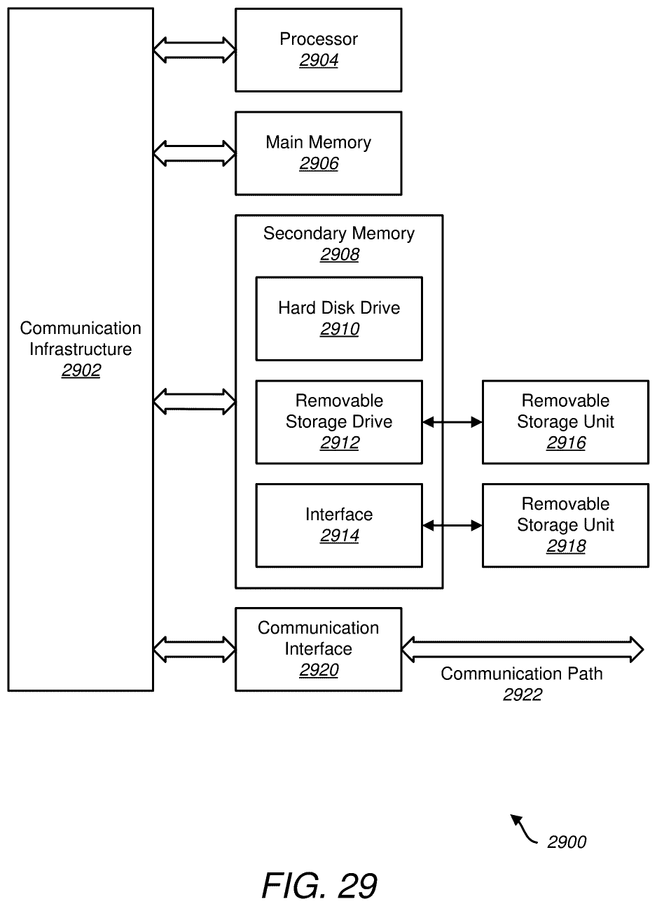

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2900 is shown in FIG. 29. Blocks depicted in the figures above, such as the blocks in FIGS. 1, 2, and 3, may execute on one or more computer systems 2900. Furthermore, each of the steps of the flowcharts depicted in this disclosure may be implemented on one or more computer systems 2900.

Computer system 2900 includes one or more processors, such as processor 2904. Processor 2904 may be, for example, a special purpose processor, general purpose processor, microprocessor, or digital signal processor. Processor 2904 may be connected to a communication infrastructure 2902 (for example, a bus or network). Computer system 2900 may also include a main memory 2906, such as random access memory (RAM), and may also include a secondary memory 2908.

Secondary memory 2908 may include, for example, a hard disk drive 2910 and/or a removable storage drive 2912, representing a magnetic tape drive, an optical disk drive, or the like. Removable storage drive 2912 may read from and/or write to a removable storage unit 2916 in a well-known manner. Removable storage unit 2916 represents a magnetic tape, optical disk, or the like, which is read by and written to by removable storage drive 2912. As will be appreciated by persons skilled in the relevant art(s), removable storage unit 2916 includes a computer usable storage medium having stored therein computer software and/or data.

In alternative implementations, secondary memory 2908 may include other similar means for allowing computer programs or other instructions to be loaded into computer system 2900. Such means may include, for example, a removable storage unit 2918 and an interface 2914. Examples of such means may include a program cartridge and cartridge interface (such as that found in video game devices), a removable memory chip (such as an EPROM or PROM) and associated socket, a thumb drive and USB port, and other removable storage units 2918 and interfaces 2914 which allow software and data to be transferred from removable storage unit 2918 to computer system 2900.

Computer system 2900 may also include a communications interface 2920. Communications interface 2920 allows software and data to be transferred between computer system 2900 and external devices. Examples of communications interface 2920 may include a modem, a network interface (such as an Ethernet card), a communications port, etc. Software and data transferred via communications interface 2920 are in the form of signals which may be electronic, electromagnetic, optical, or other signals capable of being received by communications interface 2920. These signals are provided to communications interface 2920 via a communications path 2922. Communications path 2922 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2916 and 2918 or a hard disk installed in hard disk drive 2910. These computer program products are means for providing software to computer system 2900. Computer programs (also called computer control logic) may be stored in main memory 2906 and/or secondary memory 2908. Computer programs may also be received via communications interface 2920. Such computer programs, when executed, enable the computer system 2900 to implement the present disclosure as discussed herein. In particular, the computer programs, when executed, enable processor 2904 to implement the processes of the present disclosure, such as any of the methods described herein. Accordingly, such computer programs represent controllers of the computer system 2900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

1. A method comprising:
determining, based on a position of a block relative to a boundary and a property of the block, a first reference line offset and a second reference line offset that are different;
determining samples of a reference line based on the first reference line offset and the second reference line offset; and
predicting the block based on the samples of the reference line and an intra prediction mode.

2. The method of claim 1, wherein:
the boundary is one of a boundary of a picture that the block is located within, a boundary of a coding tree unit that the block is located within, a boundary of a slice that the block is located within, or a boundary of a tile that the block is located within; and
wherein the boundary is one of a top boundary or a left boundary.

3. The method of claim 1, wherein the first reference line offset is set to a predetermined offset value based on a top row or left column of samples of the block being directly adjacent to the boundary.

4. The method of claim 3, wherein:
the boundary is a top boundary, the first reference line offset is a vertical reference line offset, and the second reference line offset is a horizontal reference line offset; or
the boundary is a left boundary, the first reference line offset is a horizontal reference line offset, and the second reference line offset is a vertical reference line offset.

5. The method of claim 1, wherein the determining the samples of the reference line based on the first reference line offset and the second reference line offset comprises:
determining a main set of samples of the reference line based on one of the first reference line offset or the second reference line offset, wherein the one of the first reference line offset or the second reference line offset is determined based on the intra prediction mode; and
determining an extended set of samples of the reference line based on the first reference line offset and the second reference line offset.

6. The method of claim 1, wherein the second reference line offset is determined based on the property of the block.

7. The method of claim 6, wherein the property of the block is:
at least one of a height of the block or a width of the block; or
an aspect ratio of the block.

8. A decoder comprising:
one or more processors; and
memory storing instructions that, when executed by the one or more processors, cause the decoder to:
determine, based on a position of a block relative to a boundary and a property of the block, a first reference line offset and a second reference line offset that are different;
determine samples of a reference line based on the first reference line offset and the second reference line offset; and
predict the block based on the samples of the reference line and an intra prediction mode.

9. The decoder of claim 8, wherein:
the boundary is one of a boundary of a picture that the block is located within, a boundary of a coding tree unit that the block is located within, a boundary of a slice that the block is located within, or a boundary of a tile that the block is located within; and
wherein the boundary is one of a top boundary or a left boundary.

10. The decoder of claim 8, wherein the first reference line offset is set to a predetermined offset value based on a top row or left column of samples of the block being directly adjacent to the boundary.

11. The decoder of claim 10, wherein:
the boundary is a top boundary, the first reference line offset is a vertical reference line offset, and the second reference line offset is a horizontal reference line offset; or
the boundary is a left boundary, the first reference line offset is a horizontal reference line offset, and the second reference line offset is a vertical reference line offset.

12. The decoder of claim 8, wherein to determine the samples of the reference line based on the first reference line offset and the second reference line offset, the decoder is further caused to:
determine a main set of samples of the reference line based on one of the first reference line offset or the second reference line offset, wherein the one of the first reference line offset or the second reference line offset is determined based on the intra prediction mode; and
determine an extended set of samples of the reference line based on the first reference line offset and the second reference line offset.

13. The decoder of claim 8, wherein the second reference line offset is determined based on the property of the block.

14. The decoder of claim 13, wherein the property of the block is:
at least one of a height of the block or a width of the block; or
an aspect ratio of the block.

15. A non-transitory computer-readable medium comprising instructions that, when executed by one or more processors of a decoder, cause the decoder to:
determine, based on a position of a block relative to a boundary and a property of the block, a first reference line offset and a second reference line offset that are different;
determine samples of a reference line based on the first reference line offset and the second reference line offset; and
predict the block based on the samples of the reference line and an intra prediction mode.

16. The non-transitory computer-readable medium of claim 15, wherein:
the boundary is one of a boundary of a picture that the block is located within, a boundary of a coding tree unit that the block is located within, a boundary of a slice that the block is located within, or a boundary of a tile that the block is located within; and
wherein the boundary is one of a top boundary or a left boundary.

17. The non-transitory computer-readable medium of claim 15, wherein the first reference line offset is set to a predetermined offset value based on a top row or left column of samples of the block being directly adjacent to the boundary.

18. The non-transitory computer-readable medium of claim 17, wherein:
the boundary is a top boundary, the first reference line offset is a vertical reference line offset, and the second reference line offset is a horizontal reference line offset; or
the boundary is a left boundary, the first reference line offset is a horizontal reference line offset, and the second reference line offset is a vertical reference line offset.

19. The non-transitory computer-readable medium of claim 15, wherein the second reference line offset is determined based on the property of the block.

20. The non-transitory computer-readable medium of claim 19, wherein the property of the block is:
at least one of a height of the block or a width of the block; or
an aspect ratio of the block.
